(19) United States
(12) Patent Application Publication
(10) Pub. No.: US 2026/0162022 A1
(43) Pub. Date: Jun. 11, 2026

(54) Two-Stage Boosting for Training a Decision-Tree Ensemble

(71) Applicant: PALO ALTO NETWORKS, INC., Santa Clara, CA (US)

(72) Inventors: Gal Itzhak, Holon (IL); Yinnon Meshi, Kibbutz Revivim (IL); Tuvia Newman, Kiryat Gat (IL); Yaron Cohen, Kiryat Ono (IL)

(21) Appl. No.: 18/974,885

(22) Filed: Dec. 10, 2024

(51) Int. Cl. G06N 20/20

(52) U.S. Cl. CPC G06N 20/20

(57) ABSTRACT

A method for training, on a training set of cybersecurity-incident samples, a boosted ensemble of N decision trees configured to prioritize cybersecurity incidents based on features of the incidents includes training a first k of the decision trees in the ensemble on the cybersecurity-incident samples while excluding a predetermined subset of the features from each of the cybersecurity-incident samples, and subsequently to training the first k of the decision trees, completing the training of the boosted ensemble, by training N-k of the decision trees that follow the first k of the decision trees in the ensemble without excluding the predetermined subset of the features. Other embodiments are also described.

### FIELD OF EMBODIMENTS OF THE INVENTION

Embodiments of the present invention relate generally to the field of machine learning, and specifically to boosted ensembles of decision trees.

### BACKGROUND

Boosted ensembles of decision trees have emerged as a powerful technique in the field of machine learning, particularly for tasks involving classification and regression. A decision tree is a model that makes decisions based on a series of binary splits in the data, leading to a tree-like structure where each leaf node represents a predicted outcome. While decision trees are intuitive and easy to interpret, they can suffer from issues such as overfitting and limited predictive power when used in isolation.

Boosting is an ensemble technique that aims to improve the performance of decision trees by combining multiple weak learners to form a strong learner. In the context of decision trees, boosting involves training a sequence of trees, where each tree is trained to correct the errors made by the previous trees. This iterative process results in a model that is more accurate and robust than any individual tree.

One of the most popular boosting algorithms is Gradient Boosting, which optimizes the model by minimizing a loss function through gradient descent. Gradient Boosting is described in Friedman, J. H. (2001), Greedy function approximation: A gradient boosting machine, Annals of Statistics, 29(5), 1189-1232, whose disclosure is incorporated herein by reference. Another well-known algorithm is Adaptive Boosting (AdaBoost), which adjusts the weights of incorrectly classified instances, giving them more importance in subsequent iterations. Adaptive Boosting is described in Freund, Y., & Schapire, R. E. (1997), A decision-theoretic generalization of on-line learning and an application to boosting, Journal of Computer and System Sciences, 55(1), 119-139, whose disclosure is incorporated herein by reference.

### SUMMARY

There is provided, in accordance with some embodiments of the present invention, a system for training, on a training set of cybersecurity-incident samples, a boosted ensemble of N decision trees configured to prioritize cybersecurity incidents based on features of the incidents. The system includes at least one input interface and a processor. The processor is configured to receive the training set via the input interface, to train a first k of the decision trees in the boosted ensemble on the cybersecurity-incident samples while excluding a predetermined subset of the features from each of the cybersecurity-incident samples, and to complete the training of the boosted ensemble, subsequently to training the first k of the decision trees, by training N-k of the decision trees that follow the first k of the decision trees in the boosted ensemble without excluding the predetermined subset of the features.

There is further provided, in accordance with some embodiments of the present invention, a method for training, on a training set of cybersecurity-incident samples, a boosted ensemble of N decision trees configured to prioritize cybersecurity incidents based on features of the incidents. The method includes training a first k of the decision trees in the boosted ensemble on the cybersecurity-incident samples while excluding a predetermined subset of the features from each of the cybersecurity-incident samples, and subsequently to training the first k of the decision trees, completing the training of the boosted ensemble, by training N-k of the decision trees that follow the first k of the decision trees in the boosted ensemble without excluding the predetermined subset of the features.

In some embodiments, training the boosted ensemble includes training the boosted ensemble using Gradient Boosting.

In some embodiments, the predetermined subset of the features includes a feature indicating a percentage of previous incidents of the same type that were legitimate.

In some embodiments, the predetermined subset of the features includes those of the features that are less objective than others of the features.

In some embodiments, the predetermined subset of the features includes those of the features that are less reliable than others of the features.

In some embodiments, the predetermined subset of the features includes at least one feature relying on third-party data.

In some embodiments, the method further includes, prior to training the boosted ensemble:
training a preliminary boosted ensemble on the training set, without excluding any of the features; and
assigning, to the subset, those of the features for which a measure of importance to the preliminary boosted ensemble exceeds a predetermined threshold.

There is further provided, in accordance with some embodiments of the present invention, a computer software product including a tangible non-transitory computer-readable medium in which program instructions are stored. The instructions, when read by a processor, cause the processor to train, on a training set of cybersecurity-incident samples, a boosted ensemble of N decision trees configured to prioritize cybersecurity incidents based on features of the incidents, by training a first k of the decision trees in the boosted ensemble on the cybersecurity-incident samples while excluding a predetermined subset of the features from each of the cybersecurity-incident samples, and subsequently to training the first k of the decision trees, completing the training of the boosted ensemble, by training N-k of the decision trees that follow the first k of the decision trees in the boosted ensemble without excluding the predetermined subset of the features.

The present invention will be more fully understood from the following detailed description of embodiments thereof, taken together with the drawings, in which:

### BRIEF DESCRIPTION OF THE DRAWINGS

FIG. 1 is a schematic illustration of a system for prioritizing cybersecurity incidents, in accordance with some embodiments of the present invention;

FIG. 2 is a flow diagram for a method for training a boosted ensemble of decision trees, in accordance with some embodiments of the present invention; and

FIG. 3 is a flow diagram for a method for identifying features overly correlated with the tags of training samples, in accordance with some embodiments of the present invention.

### DETAILED DESCRIPTION

### Overview

Boosted ensembles of decision trees, which are trained on training sets of tagged samples, often perform poorly when one or more of the sample features are highly correlated with the tagging but are not sufficiently robust, e.g., due to being calculated or assigned inconsistently. In particular, an ensemble that is overly reliant on non-robust features is typically unstable, in that predictions of the ensemble may vary significantly with slight modifications in feature values.

Embodiments of the present invention address this problem by providing a two-stage boosting technique that reduces the impact of any non-robust features, thus facilitating training a more stable model. In the first stage, a first sequence of decision trees is trained while ignoring the non-robust features. Subsequently, in the second stage, a second sequence of decision trees, which follows the first sequence in the ensemble, is trained without ignoring the non-robust features.

In some embodiments, the boosting technique described herein is used in cybersecurity applications, such as in the prioritization of cybersecurity incidents. Alternatively, the boosting technique described herein is used in other applications such as fraud detection, customer segmentation, credit scoring, and medical diagnoses.

### System Description

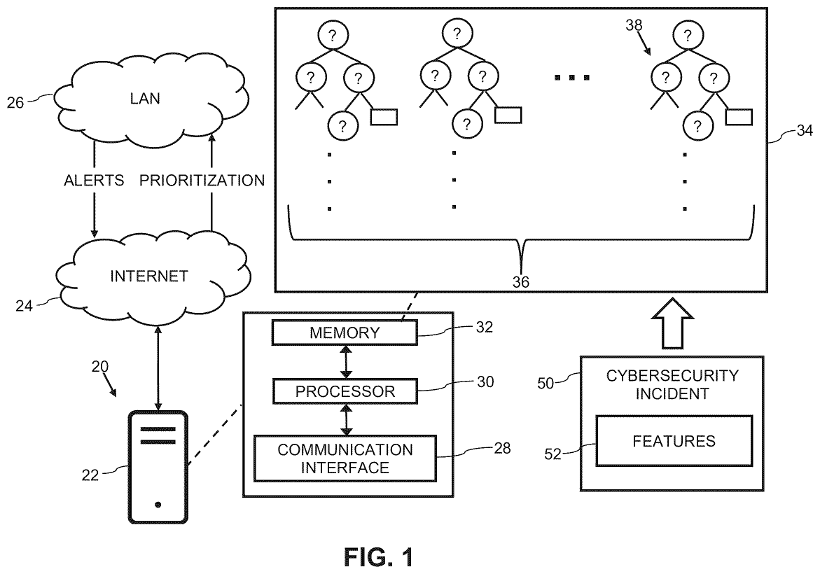

Reference is initially made to FIG. 1, which is a schematic illustration of a system 20 for prioritizing cybersecurity incidents 50, in accordance with some embodiments of the present invention.

System 20 comprises at least one server 22 configured to receive cybersecurity alerts from a local area network (LAN) 26, and/or from any other source, via a computer network 24, such as the Internet. Server 22 comprises a communication interface 28, a processor 30, and a memory 32, such as a random access memory. Processor 30 is configured to receive the alerts via communication interface 28. Processor 30 is further configured to define cybersecurity incidents 50 based on the alerts, by grouping together alerts that appear to correspond to the same incident. The processor is further configured to prioritize incidents 50 using a trained model 34 loaded into memory 32, and to communicate the prioritization, e.g., to a security operations center server connected to local area network 26, via the communication interface. For example, in some embodiments, the processor communicates the prioritization by communicating each incident with a numerical or qualitative score indicating the assessed risk of the incident, whereby greater risk corresponds to greater priority.

Trained model 34 includes a boosted ensemble 36 of N decision trees 38, N typically being between 100 and 1000, configured to prioritize cybersecurity incidents 50 based on features 52 of the incidents. Typically, features 52 are tabular, i.e., the features can be organized in a structured format, as opposed to the non-tabular features used in other types of machine-learning models such as models used for natural language or image processing. Examples of features 52 include the type of incident, the total number of alerts that were grouped together to define the incident, the types of alerts, the number of alerts of each type, the severities of the alerts, the sources from which the alerts were received, and scores indicating the accuracy and/or precision of each of the sources. (Example of sources include antivirus software or other agents installed on devices connected to local area network 26.) As another example, features 52 may include an “incident precision” feature indicating the percentage of previous incidents of the same type that were legitimate (i.e., that were “true positives”), i.e., each incident may have an incident precision feature indicating the percentage of previous incidents of the same type as the incident that were legitimate.

In some embodiments, decision trees 38 are regression trees, which assign, to each cybersecurity incident, a numerical score corresponding to the priority level of the incident. In other embodiments, decision trees 38 are classification trees, which classify each cybersecurity incident (e.g., as “high priority,” “medium priority,” or “low priority”), thereby indicating the priority level of the incident. Each decision tree 38 may have any suitable number of levels, such as between six and eight levels.

Processor 30, or any other processor, is configured to receive a training set of cybersecurity-incident samples via at least one input interface, e.g., via communication interface 28 and/or a flash drive interface. The processor is further configured to train boosted ensemble 36 on the training set, as described in detail below with reference to the subsequent figures.

In general, each of the processors mentioned herein may be embodied as a single processor or as a cooperatively networked or clustered set of processors, e.g., in a cloud-computing platform. The functionality of each of the processors may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, the processor may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Training the Boosted Ensemble

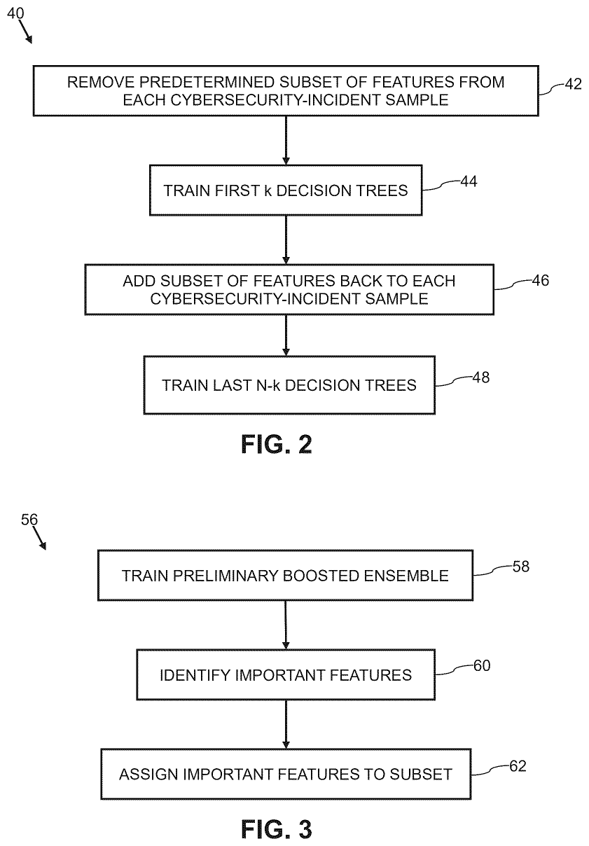

Reference is now made to FIG. 2, which is a flow diagram for a method 40 for training boosted ensemble 36, in accordance with some embodiments of the present invention.

Per method 40, the processor trains the boosted ensemble on a training set of cybersecurity-incident samples, each of which is tagged with a respective tag—in particular, a numerical score or a class-indicating the priority level of the sample. The training is performed using Gradient Boosting, Adaptive Boosting, or any other suitable boosting technique known in the art. However, as opposed to conventional boosting, method 40 begins with a feature-removing step 42, at which a predetermined subset of features is removed from each of the cybersecurity-incident samples. Subsequently, the first k decision trees in the ensemble are trained on the cybersecurity-incident samples at a first training step 44, thereby completing the first stage of the training. Next, in the second stage of the training, the predetermined subset of features is added back to each of the cybersecurity-incident samples at a feature-adding step 46, and the last N-k decision trees in the ensemble (which follow the first k trees) are then trained at a second training step 48, thereby completing the training of the boosted ensemble.

In general, k can be set to any suitable number. The optimal value of k may be found based on experimentation and/or any relevant theoretical considerations.

More generally, the scope of the present invention includes any technique for training the first k decision trees while excluding the predetermined subset of the features from each of the cybersecurity-incident samples, and then training the following N-k decision trees without excluding the predetermined subset of the features. For example, in some embodiments, rather than explicitly removing the feature subset, the training algorithm is instructed to ignore the feature subset during the training of the first k decision trees. The training algorithm is then instructed not to ignore the feature subset during the training of the last N-k decision trees, or alternatively, the training algorithm includes the feature subset even without any special instruction.

In some embodiments, the predetermined subset includes features that are less objective than other features, such as features that depend on qualitative labels applied by a user. Alternatively or additionally, the predetermined subset includes features that are less reliable (or “consistent”) than other features, such as features that are calculated differently (i.e., using different methodologies) by different sources and/or that are sometimes missing. Alternatively or additionally, the predetermined subset includes at least one feature relying on third-party data (e.g., data from customers that utilize system 20 (FIG. 1) for incident prioritization), given that such data may be provided inconsistently. For example, in some embodiments, the subset includes the incident precision feature described above with reference to FIG. 1, given that this feature typically relies on third-party data.

Alternatively or additionally, the predetermined subset includes features that are overly correlated with the tags of the training samples, given that a model that relies on such features is typically unstable. In this regard, reference is now made to FIG. 3, which is a flow diagram for a method 56 for identifying such features, in accordance with some embodiments of the present invention.

In some embodiments, prior to training boosted ensemble 36, the processor performs method 56. Per method 56, a preliminary boosted ensemble is trained on the training set (or on a different training set), without excluding any of the features from the samples in the training set, at a training step 58. Subsequently, at a feature-identifying step 60, the processor identifies features for which a measure of importance to the preliminary boosted ensemble exceeds a predetermined threshold, the relative importance of these features indicating that these features are overly correlated with the tags of the training samples. The measure of feature importance can be based, for example, on information gain, permutation methods, or Shapley Additive explanations. Next, at an assigning step 62, the processor assigns the identified features to the subset of features that is to be excluded from the training of the first k decision trees.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A system for training, on a training set of cybersecurity-incident samples, a boosted ensemble of N decision trees configured to prioritize cybersecurity incidents based on features of the incidents, the system comprising:
at least one input interface; and
a processor, configured to:
receive the training set via the input interface,
train a first k of the decision trees in the boosted ensemble on the cybersecurity-incident samples while excluding a predetermined subset of the features from each of the cybersecurity-incident samples, and
subsequently to training the first k of the decision trees, complete the training of the boosted ensemble, by training N-k of the decision trees that follow the first k of the decision trees in the boosted ensemble without excluding the predetermined subset of the features.

2. The system according to claim 1, wherein the processor is configured to train the boosted ensemble using Gradient Boosting.

3. The system according to claim 1, wherein the predetermined subset of the features includes those of the features that are less objective than others of the features.

4. The system according to claim 1, wherein the predetermined subset of the features includes those of the features that are less reliable than others of the features.

5. The system according to claim 1, wherein the predetermined subset of the features includes at least one feature relying on third-party data.

6. The system according to claim 1, wherein the processor is further configured to, prior to training the boosted ensemble:
train a preliminary boosted ensemble on the training set, without excluding any of the features, and
assign, to the subset, those of the features for which a measure of importance to the preliminary boosted ensemble exceeds a predetermined threshold.

7. A method for training, on a training set of cybersecurity-incident samples, a boosted ensemble of N decision trees configured to prioritize cybersecurity incidents based on features of the incidents, the method comprising:
training a first k of the decision trees in the boosted ensemble on the cybersecurity-incident samples while excluding a predetermined subset of the features from each of the cybersecurity-incident samples; and
subsequently to training the first k of the decision trees, completing the training of the boosted ensemble, by training N-k of the decision trees that follow the first k of the decision trees in the boosted ensemble without excluding the predetermined subset of the features.

8. The method according to claim 7, wherein training the boosted ensemble comprises training the boosted ensemble using Gradient Boosting.

9. The method according to claim 7, wherein the predetermined subset of the features includes a feature indicating a percentage of previous incidents of the same type that were legitimate.

10. The method according to claim 7, wherein the predetermined subset of the features includes those of the features that are less objective than others of the features.

11. The method according to claim 7, wherein the predetermined subset of the features includes those of the features that are less reliable than others of the features.

12. The method according to claim 7, wherein the predetermined subset of the features includes at least one feature relying on third-party data.

13. The method according to claim 7, further comprising, prior to training the boosted ensemble:
training a preliminary boosted ensemble on the training set, without excluding any of the features; and
assigning, to the subset, those of the features for which a measure of importance to the preliminary boosted ensemble exceeds a predetermined threshold.

14. A computer software product comprising a tangible non-transitory computer-readable medium in which program instructions are stored, which instructions, when read by a processor, cause the processor to train, on a training set of cybersecurity-incident samples, a boosted ensemble of N decision trees configured to prioritize cybersecurity incidents based on features of the incidents, by:
training a first k of the decision trees in the boosted ensemble on the cybersecurity-incident samples while excluding a predetermined subset of the features from each of the cybersecurity-incident samples, and
subsequently to training the first k of the decision trees, completing the training of the boosted ensemble, by training N-k of the decision trees that follow the first k of the decision trees in the boosted ensemble without excluding the predetermined subset of the features.

15. The computer software product according to claim 14, wherein training the boosted ensemble includes training the boosted ensemble using Gradient Boosting.

16. The computer software product according to claim 14, wherein the predetermined subset of the features includes a feature indicating a percentage of previous incidents of the same type that were legitimate.

17. The computer software product according to claim 14, wherein the predetermined subset of the features includes those of the features that are less objective than others of the features.

18. The computer software product according to claim 14, wherein the predetermined subset of the features includes those of the features that are less reliable than others of the features.

19. The computer software product according to claim 14, wherein the predetermined subset of the features includes at least one feature relying on third-party data.

20. The computer software product according to claim 14, wherein the instructions further cause the processor to, prior to training the boosted ensemble:
train a preliminary boosted ensemble on the training set, without excluding any of the features, and
assign, to the subset, those of the features for which a measure of importance to the preliminary boosted ensemble exceeds a predetermined threshold.
